(19) United States
(12) Patent Application Publication
(10) Pub. No.: US 2021/0032149 A1
(43) Pub. Date: Feb. 4, 2021

(54) GLASS MANUFACTURING APPARATUS AND METHODS INCLUDING A THERMAL SHIELD

(71) Applicant: CORNING INCORPORATED, CORNING, NY (US)

(72) Inventors: David Scott Franzen, Painted Post, NY (US); Brendan William Glover, Corning, NY (US); Bulent Kocatulum, Horseheads, NY (US); William Brashear Mattingly, III, Painted Post, NY (US)

(21) Appl. No.: 16/766,973

(22) PCT Filed: Nov. 28, 2018
(86) PCT No.: PCT/US2018/062752

§ 371 Date: May 26, 2020

Related U.S. Application Data
(60) Provisional application No. 62/592,036, filed on Nov. 29, 2017.

(51) Int. Cl. C03B 17/06

(52) U.S. Cl. CPC C03B 17/067; C03B 17/064

(57) ABSTRACT

A glass manufacturing apparatus includes an enclosure including an interior area and a vessel positioned at least partially within the interior area of the enclosure. The vessel includes a trough and a forming wedge including a pair of downwardly inclined surfaces that converge at a root of the vessel. A draw plane extends from the root of the vessel through an opening of the enclosure in a draw direction. The apparatus includes a thermal shield moveable along an adjustment direction extending perpendicular to the draw plane. The thermal shield includes a non-metallic outer shell and a thermal insulating core. Additionally, methods of manufacturing a glass ribbon with the glass manufacturing apparatus are provided.

### CROSS REFERENCE TO RELATED APPLICATIONS

This application claims the benefit of priority of U.S. Provisional Application Ser. No. 62/592,036 filed Nov. 29, 2017 on the contents of which are relied upon and incorporated herein by reference in their entirety as if fully set forth below.

### FIELD

The present disclosure relates generally to glass manufacturing apparatus and methods of manufacturing a glass ribbon and, more particularly, to a glass manufacturing apparatus including a thermal shield and methods of manufacturing a glass ribbon with the glass manufacturing apparatus.

### BACKGROUND

Glass manufacturing apparatus including an enclosure, a vessel, and a thermal shield are known. Additionally, it is known to position the vessel at least partially within an interior area of the enclosure, where the vessel includes a trough and a forming wedge including a pair of downwardly inclined surfaces that converge at a root of the vessel. Moreover, methods of manufacturing a glass ribbon with a glass manufacturing apparatus are known.

### SUMMARY

The following presents a summary of the disclosure to provide a basic understanding of some embodiments described in the detailed description.

In some embodiments, a glass manufacturing apparatus can include an enclosure including an interior area. The apparatus can include a vessel positioned at least partially within the interior area of the enclosure, and the vessel can include a trough and a forming wedge including a pair of downwardly inclined surfaces that converge at a root of the vessel. The apparatus can include a thermal shield obstructing at least a portion of an opening of the enclosure, and the thermal shield can include a non-metallic outer shell and a thermal insulating core.

In some embodiments, the non-metallic outer shell can include a ceramic material.

In some embodiments, the ceramic material can include silicon carbide.

In some embodiments, the non-metallic outer shell can include a first surface defining an outer surface of the thermal shield and a second surface facing the thermal insulating core. A thickness of the non-metallic outer shell defined between the first surface and the second surface can be from about 2.8 millimeters to about 3.5 millimeters.

In some embodiments, the thickness of the non-metallic outer shell defined between the first surface and the second surface can be from about 3 millimeters to about 3.3 millimeters.

In some embodiments, the thermal insulating core can be enclosed entirely within the non-metallic outer shell.

In some embodiments, the non-metallic outer shell can define a continuous surface.

In some embodiments, the thermal shield can be moveable along an adjustment direction extending perpendicular to a draw plane. The draw plane can extend from the root of the vessel through the opening of the enclosure.

In some embodiments, a method of manufacturing a glass ribbon with the glass manufacturing apparatus can include flowing molten material along each surface of the pair of downwardly inclined surfaces, fusing the flowing molten material off the root of the vessel into a glass ribbon, and drawing the glass ribbon along a draw path extending from the root of the vessel through the opening of the enclosure.

In some embodiments, a glass manufacturing apparatus can include an enclosure including an interior area. The apparatus can include a vessel positioned at least partially within the interior area of the enclosure, and the vessel can include a trough and a forming wedge including a pair of downwardly inclined surfaces that converge at a root of the vessel. The apparatus can include a thermal shield moveable along an adjustment direction extending perpendicular to a draw plane. The draw plane can extend from the root of the vessel through an opening of the enclosure in a draw direction. The thermal shield can include a non-metallic outer shell.

In some embodiments, the non-metallic outer shell can include a ceramic material.

In some embodiments, the ceramic material can include silicon carbide.

In some embodiments, the non-metallic outer shell can define a continuous surface.

In some embodiments, a dimension of the thermal shield extending parallel to the draw direction from a first outer location of the non-metallic outer shell to a second outer location of the non-metallic outer shell can be from about 1.5 centimeters to about 2.5 centimeters.

In some embodiments, the thermal shield can include a thermal insulating core, and the non-metallic outer shell can include a first surface defining an outer surface of the thermal shield and a second surface facing the thermal insulating core.

In some embodiments, a thickness of the non-metallic outer shell defined between the first surface and the second surface can be from about 2.8 millimeters to about 3.5 millimeters.

In some embodiments, the thermal insulating core can be enclosed entirely within the non-metallic outer shell.

In some embodiments, a method of manufacturing a glass ribbon with the glass manufacturing apparatus can include moving the thermal shield along the adjustment direction to adjust a width of the opening.

In some embodiments, the method can further include flowing molten material along each surface of the pair of downwardly inclined surfaces, fusing the flowing molten material off the root of the vessel into a glass ribbon, and drawing the glass ribbon along the draw plane in the draw direction.

### BRIEF DESCRIPTION OF THE DRAWINGS

These and other features, embodiments, and advantages are better understood when the following detailed description is read with reference to the accompanying drawings, in which:

FIG. 1 schematically illustrates an exemplary embodiment of a glass manufacturing apparatus in accordance with embodiments of the disclosure;

FIG. 2 shows a perspective cross-sectional view of the glass manufacturing apparatus along line 2-2 of FIG. 1 in accordance with embodiments of the disclosure;

FIG. 3 shows an enlarged end view of a portion of the cross-section of the glass manufacturing apparatus of FIG. 2 in accordance with embodiments of the disclosure;

FIG. 4 shows a top view of an exemplary embodiment of a thermal shield taken along lines 4-4 of FIG. 3 in accordance with embodiments of the disclosure;

FIG. 5 shows a cross-sectional view of the thermal shield taken along line 5-5 of FIG. 4 in accordance with embodiments of the disclosure;

FIG. 6 shows a cross-sectional view of the thermal shield taken along line 6-6 of FIG. 4 in accordance with embodiments of the disclosure; and

FIG. 7 shows a bar chart based on an analysis of exemplary thermal shields in accordance with embodiments of the disclosure, where the vertical axis represents temperature of a root of a glass ribbon in degrees Celsius (° C.) and the horizontal axis represents different thermal shields being compared.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

It is to be understood that specific embodiments disclosed herein are intended to be exemplary and therefore non-limiting. For purposes of the disclosure, in some embodiments, a glass manufacturing apparatus can optionally include a glass forming apparatus that forms a glass ribbon and/or a glass sheet from a quantity of molten material. For example, in some embodiments, the glass manufacturing apparatus can optionally include a glass forming apparatus such as a slot draw apparatus, float bath apparatus, down-draw apparatus, up-draw apparatus, press-rolling apparatus, or other glass forming apparatus.

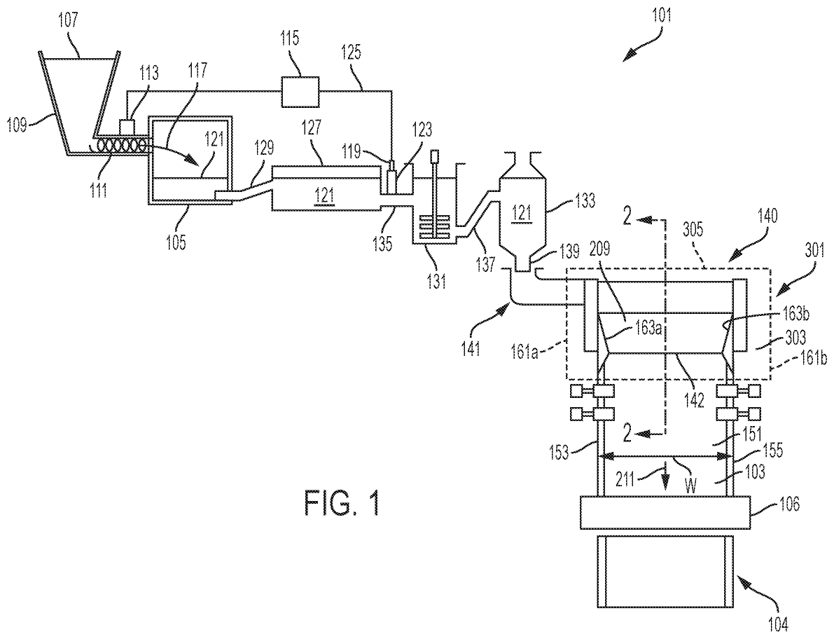

As schematically illustrated in FIG. 1, in some embodiments, an exemplary glass manufacturing apparatus 101 can include a glass forming apparatus including a forming vessel 140 designed to produce a glass ribbon 103 from a quantity of molten material 121. In some embodiments, the glass ribbon 103 can include a central portion 151 disposed between opposite, relatively thick edge beads formed along a first edge 153 and a second edge 155 of the glass ribbon 103. Additionally, in some embodiments, a glass sheet 104 can be separated from the glass ribbon 103 by a glass separation apparatus 106. Although not shown, in some embodiments, before or after separation of the glass sheet 104 from the glass ribbon 103, the relatively thick edge beads formed along the first edge 153 and the second edge 155 can be removed to provide the central portion 151 as a high-quality glass sheet 104 having a uniform thickness. In some embodiments, the resulting high-quality glass sheet 104 can be employed in a variety of display applications, including, but not limited to, liquid crystal displays (LCDs), electrophoretic displays (EPD), organic light emitting diode displays (OLEDs), plasma display panels (PDPs), and other electronic displays.

In some embodiments, the glass manufacturing apparatus 101 can include a melting vessel 105 oriented to receive batch material 107 from a storage bin 109. The batch material 107 can be introduced by a batch delivery device 111 powered by a motor 113. In some embodiments, an optional controller 115 can be operated to activate the motor 113 to introduce a desired amount of batch material 107 into the melting vessel 105, as indicated by arrow 117. The melting vessel 105 can heat the batch material 107 to provide molten material 121. In some embodiments, a glass melt probe 119 can be employed to measure a level of molten material 121 within a standpipe 123 and communicate the measured information to the controller 115 by way of a communication line 125.

Additionally, in some embodiments, the glass manufacturing apparatus 101 can include a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 to pass through an interior pathway of the first connecting conduit 129 from the melting vessel 105 to the fining vessel 127. Additionally, in some embodiments, bubbles can be removed from the molten material 121 within the fining vessel 127 by various techniques.

In some embodiments, the glass manufacturing apparatus 101 can further include a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 to pass through an interior pathway of the second connecting conduit 135 from the fining vessel 127 to the mixing chamber 131.

Additionally, in some embodiments, the glass manufacturing apparatus 101 can include a delivery vessel 133 that can be located downstream from the mixing chamber 131. In some embodiments, the delivery vessel 133 can condition the molten material 121 to be fed into an inlet conduit 141. For example, the delivery vessel 133 can function as an accumulator and/or flow controller to adjust and provide a consistent flow of molten material 121 to the inlet conduit 141. As shown, the mixing chamber 131 can be coupled to the delivery vessel 133 by way of a third connecting conduit 137. In some embodiments, molten material 121 can be gravity fed from the mixing chamber 131 to the delivery vessel 133 by way of the third connecting conduit 137. For example, in some embodiments, gravity can drive the molten material 121 to pass through an interior pathway of the third connecting conduit 137 from the mixing chamber 131 to the delivery vessel 133.

As further illustrated, in some embodiments, a delivery pipe 139 can be positioned to deliver molten material 121 to the inlet conduit 141 of the forming vessel 140. Various embodiments of forming vessels can be provided in accordance with features of the disclosure including a forming vessel with a wedge for fusion drawing the glass ribbon, a forming vessel with a slot to slot draw the glass ribbon, or a forming vessel provided with press rolls to press roll the glass ribbon from the forming vessel. By way of illustration, the forming vessel 140 shown and disclosed below can be provided to fusion draw molten material 121 off a root 142 of a forming wedge 209 to produce the glass ribbon 103. For example, in some embodiments, the molten material 121 can be delivered from the inlet conduit 141 to the forming vessel 140. The molten material 121 can then be formed into the glass ribbon 103 based at least in part on the structure of the forming vessel 140. For example, as shown, the molten material 121 can be drawn off the bottom edge (e.g., root 142) of the forming vessel 140 along a draw path extending in a draw direction 211 of the glass manufacturing apparatus 101. In some embodiments, a width “W” of the glass ribbon 103 can extend between the first vertical edge 153 of the glass ribbon 103 and the second vertical edge 155 of the glass ribbon 103.

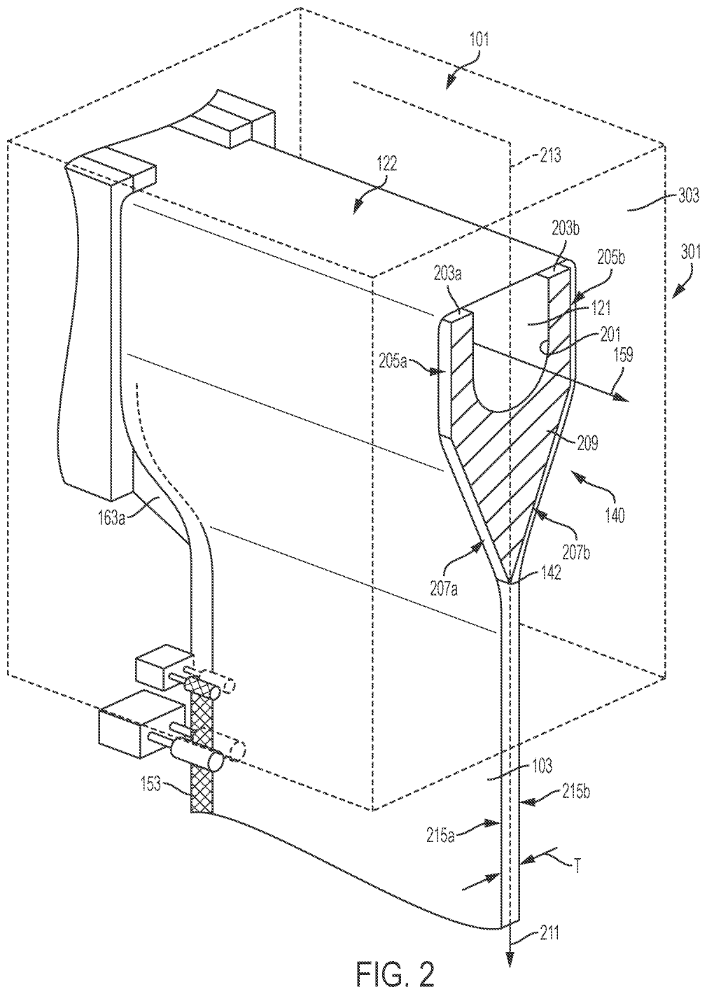

FIG. 2 shows a cross-sectional perspective view of the glass manufacturing apparatus 101 along line 2-2 of FIG. 1. In some embodiments, the forming vessel 140 can include a trough 201 oriented to receive the molten material 121 from the inlet conduit 141. For illustrative purposes, cross-hatching of the molten material 121 is removed from FIG. 2 for clarity. The forming vessel 140 can further include the forming wedge 209 including a pair of downwardly inclined converging surface portions 207a, 207b extending between opposed ends of the forming wedge 209. The pair of downwardly inclined converging surface portions 207a, 207b of the forming wedge 209 can converge along the draw direction 211 to intersect along a bottom edge of the forming wedge 209 to define the root 142 of the forming vessel 140. A draw plane 213 of the glass manufacturing apparatus 101 can extend through the root 142 along the draw direction 211. In some embodiments, the glass ribbon 103 can be drawn in the draw direction 211 along the draw plane 213. As shown, the draw plane 213 can bisect the root 142 although, in some embodiments, the draw plane 213 can extend at other orientations relative to the root 142.

Additionally, in some embodiments, the molten material 121 can flow in a direction 159 into the trough 201 of the forming vessel 140. The molten material 121 can then overflow from the trough 201 by simultaneously flowing over corresponding weirs 203a, 203b and downward over the outer surfaces 205a, 205b of the corresponding weirs 203a, 203b. Respective streams of molten material 121 can then flow along the downwardly inclined converging surface portions 207a, 207b of the forming wedge 209 to be drawn off the root 142 of the forming vessel 140, where the flows converge and fuse into the glass ribbon 103. The glass ribbon 103 can then be fusion drawn off the root 142 in the draw plane 213 along the draw direction 211. In some embodiments, the glass sheet 104 (see FIG. 1) can then be subsequently separated from the glass ribbon 103.

As shown in FIG. 2, the glass ribbon 103 can be drawn from the root 142 with a first major surface 215a of the glass ribbon 103 and a second major surface 215b of the glass ribbon 103 facing opposite directions and defining a thickness “T” of the glass ribbon 103. In some embodiments, the thickness “T’ of the glass ribbon 103 can be less than or equal to about 2 millimeters (mm), less than or equal to about 1 millimeter, less than or equal to about 0.5 millimeters, less than or equal to about 500 micrometers (μm), for example, less than or equal to about 300 micrometers, less than or equal to about 200 micrometers, or less than or equal to about 100 micrometers, although other thicknesses may be provided in further embodiments. In addition, the glass ribbon 103 can include a variety of compositions including, but not limited to, soda-lime glass, borosilicate glass, alumino-borosilicate glass, an alkali-containing glass, or an alkali-free glass.

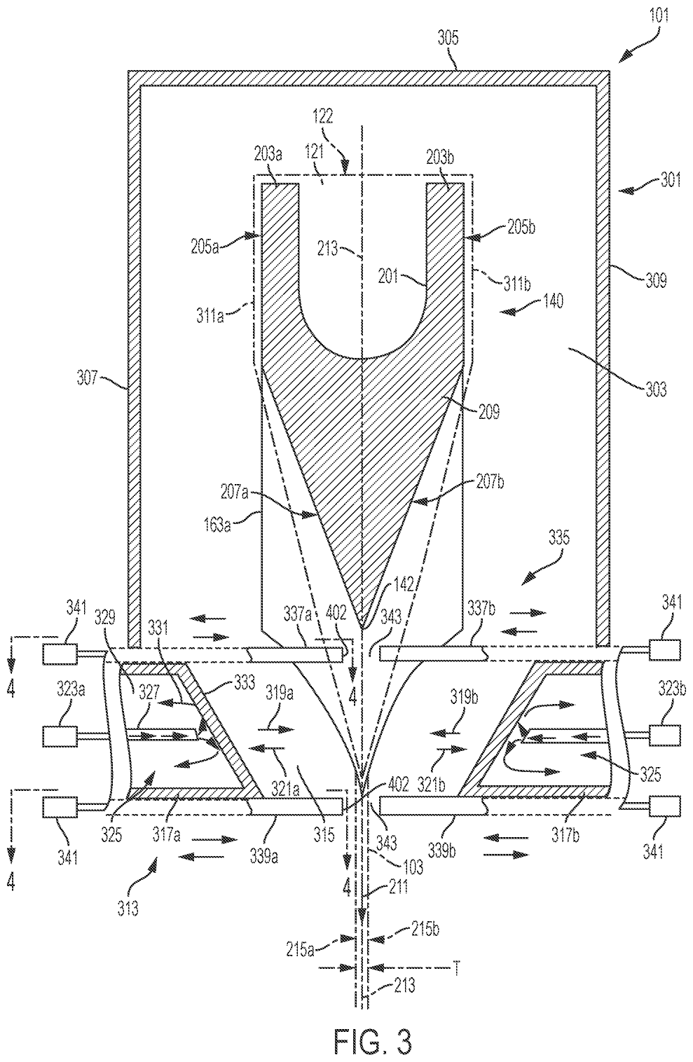

As shown schematically in FIGS. 1-3, in some embodiments, the glass manufacturing apparatus 101 can include an enclosure 301 (e.g., housing) including an interior volume defining an interior area 303 of the enclosure 301. In some embodiments, the enclosure 301 can at least partially surround the forming vessel 140 including the forming wedge 209 of the forming vessel 140, and the forming wedge 209 and the forming vessel 140 can be positioned at least partially within the interior area 303 of the enclosure 301. As shown in FIG. 3, in some embodiments, the enclosure 301 can include an upper wall 305 extending over the upper portion of the forming vessel 140 with an inner surface of the upper wall 305 facing a free surface 122 of the molten material 121 within the trough 201 and opposed sidewalls 307, 309 attached to the upper wall 305. The opposed sidewalls 307, 309 can each include an inner surface that can face corresponding streams 311a, 311b of molten material 121 flowing over the respective outer surfaces 205a, 205b of the corresponding weirs 203a, 203b. Referring to FIG. 1, the enclosure 301 can further include end walls 161a, 161b that at least partially contain the forming vessel 140 and the forming wedge 209 of the forming vessel 140 within the interior area 303 of the enclosure 301. Accordingly, in some embodiments, the interior area 303 (e.g., a volume of the interior area 303) of the enclosure 301 can be defined at least in part by the upper wall 305, sidewalls 307, 309, and end walls 161a, 161b.

In some embodiments, the glass manufacturing apparatus 101 can further include a closure 313 mounted with respect to the enclosure 301. In some embodiments, the closure 313 can define, at least in part, a boundary (e.g., structural boundary and/or thermal boundary) between the interior area 303 of the enclosure 301 and a volume defining an area outside the interior area 303 of the enclosure 301 (e.g., downstream from the interior area 303 along the draw direction 211). Additionally, in some embodiments, the closure 313 can provide a thermal barrier to control heat transfer (e.g., one or more of radiation heat transfer, convection heat transfer, and conduction heat transfer) across the boundary defined at least in part by the closure 313 from the interior area 303 of the enclosure 301 to the area outside the interior area 303 of the enclosure 301. In some embodiments, for example, during operation of the glass manufacturing apparatus 101, a temperature of the interior area 303 of the enclosure 301, including one or more features (e.g., glass ribbon 103, forming vessel 140, root 142) positioned at least partially within the interior area 303 of the enclosure 301, can be relatively hotter than a temperature outside of the interior area 303, including one or more features positioned outside the interior area 303 of the enclosure 301 (e.g., glass ribbon 103 located downstream from the closure 313 along the draw direction 211). Accordingly, in some embodiments, one or more features of the closure 313 can define, at least in part, a thermal boundary between a relatively higher temperature of the interior area 303 of the enclosure 301 and a relatively lower temperature outside of the interior area 303, thereby controlling heat transfer (e.g., one or more of radiation heat transfer, convection heat transfer, and conduction heat transfer) between the relatively higher temperature of the interior area 303 and the relatively lower temperature outside of the interior area 303.

In some embodiments, the closure 313 can include a pair of doors 317a, 317b that can optionally be movable to limit a size of an opening 315 into the interior area 303 of the enclosure 301. For example, in some embodiments, the pair of doors 317a, 317b can optionally be movable in an extension direction 319a, 319b toward the draw plane 213 or in a retraction direction 321a, 321b away from the draw plane 213. In some embodiments, the extension direction 319a, 319b and/or the retraction direction 321a, 321b can extend perpendicular to the draw plane 213. For example, in some embodiments at least a directional component of the extension direction 319a, 319b and/or at least a directional component of the retraction direction 321a, 321b can extend perpendicular to the draw plane 213. In some embodiments, actuators 323a, 323b can be provided to move the pair of doors 317a, 317b along at least one of the extension direction 319a, 319b and the retraction direction 321a, 321b to adjust the size of the opening 315 into the interior area 303 of the enclosure 301 and control heat transfer between the relatively higher temperature of the interior area 303 and the relatively lower temperature outside of the interior area 303.

In some embodiments, the pair of doors 317a, 317b, if provided, can further include additional features designed to adjust the temperature of portions of the molten material 121 to provide desirable features of the glass ribbon 103 discussed above. For example, in some embodiments, one or both of the doors 317a, 317b can include a cooling device 325. An embodiment of the cooling device 325 will be discussed with respect to a first door 317a of the pair of doors 317a, 317b with the understanding that, as shown in FIG. 3, an identical or similar cooling device 325 can also be incorporated in the second door 317b of the pair of doors 317a, 317b without departing from the scope of the disclosure. In some embodiments, the cooling device 325 can include a fluid nozzle 327 disposed within an interior area 329 of the door 317a. The fluid nozzle 327 can direct a cooling fluid stream 331 (e.g., air stream) to a front wall 333 of the door 317a facing the draw plane 213. In some embodiments, the cooling fluid stream 331 can cool the front wall 333 based at least in part on convection heat transfer while the front wall can absorb heat based at least in part on radiation heat transfer from the glass ribbon 103 being drawn from the forming vessel 140. Accordingly, in some embodiments, the temperature of the glass ribbon 103 can be adjusted by way of the cooling device 325 to control the temperature and viscosity of the glass ribbon 103, thereby providing the glass ribbon 103 with desired characteristics (e.g., thickness “T”).

As shown in FIG. 3, the closure 313 of the glass manufacturing apparatus 101 can further include a thermal shield 335 (e.g., muffle door, slide gate) obstructing at least a portion of the opening 315 into the interior area 303 of the enclosure 301. In some embodiments, the thermal shield 335 can include an upper pair of thermal shields 337a, 337b positioned vertically above the pair of doors 317a, 317b relative to the draw direction 211. For example, in some embodiments, the upper pair of thermal shields 337a, 337b can be positioned upstream (i.e., opposite the draw direction 211) relative to the pair of doors 317a, 317b. In addition or alternatively, in some embodiments, the thermal shield 335 can include a lower pair of thermal shields 339a, 339b positioned vertically below the doors 317a, 317b relative to the draw direction 211. For example, in some embodiments, the lower pair of thermal shields 339a, 339b can be positioned downstream (i.e., in the draw direction 211) relative to the pair of doors 317a, 317b. Moreover, although not shown, in some embodiments, the thermal shield 335 (e.g., pairs of thermal shields 337a, 337b, 339a, 339b) can be located within the vertical height of the doors 317a, 317b relative to the draw direction 211. Thus, while the embodiment shown in FIG. 3 illustrates the upper pair of thermal shields 337a, 337b located entirely vertically above the doors 317a, 317b relative to the draw direction 211 and the lower pair of thermal shields 339a, 339b located entirely vertically below the doors 317a, 317b relative to the draw direction 211, in some embodiments, one or more thermal shields 335 can be located within the vertical height of the doors 317a, 317b relative to the draw direction 211. Additionally, although not shown, in some embodiments, the glass manufacturing apparatus 101 can be provided without the doors 317a, 317b, where, for example, the thermal shields 335 (e.g., a single pair of thermal shields 337a, 337b or a plurality of pairs of thermal shields 337a, 337b, 339a, 339b) can be employed without the doors 317a, 317b to define a size of the opening 315 into the interior area 303 of the enclosure 301 and to provide a boundary (e.g., structural boundary and/or thermal boundary) between the interior area 303 of the enclosure 301 and an area outside the interior area 303 of the enclosure 301.

Moreover, in some embodiments, one or more of the thermal shields 335 can be mounted to be moveable along adjustment directions to adjust the size of the opening 315 into the interior area 303 of the enclosure 301 and control heat transfer (e.g., one or more of radiation heat transfer, convection heat transfer, and conduction heat transfer) between the relatively higher temperature of the interior area 303 and the relatively lower temperature outside of the interior area 303. For example, in some embodiments, each thermal shield 337a, 339a corresponding to the first major surface 215a of the glass ribbon 103 can be movable in the extension direction 319a and/or the retraction direction 321a by a corresponding actuator 341. Additionally, in some embodiments, each thermal shield 337b, 339b corresponding to the second major surface 215b of the glass ribbon 103 can be moveable in the extension direction 319b and/or the retraction direction 321b by a corresponding actuator 341. Accordingly, in addition or alternative to the pair of doors 317a, 317b, in some embodiments, the thermal shields 335 can, likewise, be moved in the extension directions 319a, 319b and/or the retraction directions 321a, 321b to adjust the size of the opening 315 into the interior area 303 of the enclosure 301 and control heat transfer between the relatively higher temperature of the interior area 303 and the relatively lower temperature outside of the interior area 303.

In some embodiments, each thermal shield 335 of the pairs of thermal shields 337a, 337b, 339a, 339b can be positioned vertically below the root 142 of the forming wedge 209 relative to the draw direction 211 to, for example, help control the atmospheric conditions (e.g., temperature) of the interior area 303 of the enclosure 301 including the temperature of the root 142 and the temperature of the glass ribbon 103 at the root 142. In some embodiments, the forming wedge 209 can be disposed entirely within the interior area 303. Alternatively, in some embodiments part of the forming wedge 209 (e.g., root 142) can extend below one or more of the thermal shields 337a, 337b, 339a, 339b. Accordingly, in some embodiments, the thermal shields 335 can help control the atmospheric conditions (e.g., temperature) of the interior area 303 of the enclosure 301 including, for example, the temperature of one or more components (e.g., all or part of the forming wedge 209 and the glass ribbon 103) positioned within the interior area 303.

Furthermore, one or any combination of the doors 317a, 317b and the thermal shields 337a, 337b, 339a, 339b can be moved in the respective extension directions 319a, 319b to reduce the size of the opening 315 into the interior area 303 of the enclosure 301. For example, in some embodiments, reducing the size of the opening 315 into the interior area 303 can reduce heat transfer (e.g., one or more of radiation heat transfer, convection heat transfer, and conduction heat transfer) across the thermal barrier between the relatively higher temperature of the interior area 303 and the relatively lower temperature outside of the interior area 303. In some embodiments, for example during operation of the glass manufacturing apparatus 101, radiation heat transfer can be the dominant mode of heat transfer between the relatively higher temperature of the interior area 303 and the relatively lower temperature outside of the interior area 303, and reducing the size of the opening 315 into the interior area 303 can reduce transfer of heat from the interior area 303 based on radiation heat transfer. Additionally, in some embodiments, reducing the size of the opening 315 into the interior area 303 can reduce a flow of air into and/or out of the interior area 303 based on convection heat transfer. Therefore, in some embodiments, by reducing the size of the opening 315 into the interior area 303, one or any combination of the doors 317a, 317b and the thermal shields 337a, 337b, 339a, 339b can reduce at least one of radiation heat transfer and convection heat transfer across the thermal barrier between the relatively higher temperature of the interior area 303 and the relatively lower temperature outside of the interior area 303. In some embodiments, reducing heat transfer across the thermal barrier can, for example, maintain or increase the temperature of portions of the glass ribbon 103 within the interior area 303 and/or maintain or decrease the temperature of portions of the glass ribbon 103 outside the interior area 303.

Alternatively, one or any combination of the doors 317a, 317b and thermal shields 337a, 337b, 339a, 339b can be moved in the respective retraction directions 321a, 321b to increase the size of the opening 315 into the interior area 303 of the enclosure 301. For example, in some embodiments, increasing the size of the opening 315 into the interior area 303 can increase heat transfer (e.g., one or more of radiation heat transfer, convection heat transfer, and conduction heat transfer) across the thermal barrier between the relatively higher temperature of the interior area 303 and the relatively lower temperature outside of the interior area 303. In some embodiments, for example during operation of the glass manufacturing apparatus 101, radiation heat transfer can be the dominant mode of heat transfer between the relatively higher temperature of the interior area 303 and the relatively lower temperature outside of the interior area 303, and increasing the size of the opening 315 into the interior area 303 can increase transfer of heat from the interior area 303 based on radiation heat transfer. Additionally, in some embodiments, increasing the size of the opening 315 into the interior area 303 can increase a flow of air into and/or out of the interior area 303 based on convection heat transfer. Therefore, in some embodiments, by increasing the size of the opening 315 into the interior area 303, one or any combination of the doors 317a, 317b and the thermal shields 337a, 337b, 339a, 339b can increase at least one of radiation heat transfer and convection heat transfer across the thermal barrier between the relatively higher temperature of the interior area 303 and the relatively lower temperature outside of the interior area 303. In some embodiments, increasing heat transfer across the thermal barrier can, for example, maintain or decrease the temperature of portions of the glass ribbon 103 within the interior area 303 and/or maintain or increase the temperature of portions of the glass ribbon 103 outside the interior area 303.

Accordingly, in some embodiments, by adjusting the size of the opening 315 into the interior area 303 of the enclosure 301, the temperature of portions of the glass ribbon 103 within the interior area 303 as well as the temperature of portions of the glass ribbon 103 outside the interior area 303 can be adjusted to provide desirable attributes to the glass ribbon 103 being drawn from the forming vessel 140. For example, in some embodiments, reducing the temperature of the molten material 121 being drawn off the forming wedge 209 can increase the viscosity of the molten material 121 and consequently increase the thickness “T” of the glass ribbon 103 being drawn off the root 142 of the forming wedge 209. Alternatively, in some embodiments, increasing the temperature of the molten material 121 being drawn off the forming wedge 209 can decrease the viscosity of the molten material 121 and consequently decrease the thickness “T” of the glass ribbon 103 being drawn off the root 142 of the forming wedge 209.

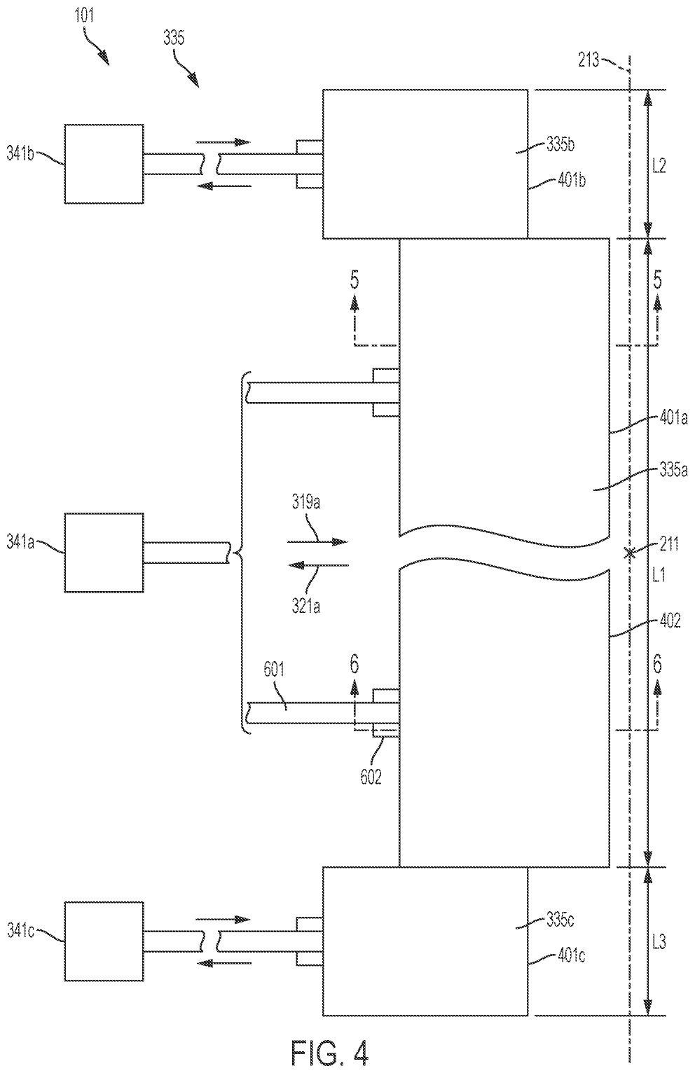

FIG. 4 shows a top view of an exemplary thermal shield 335 viewed along line 4-4 of FIG. 3. In some embodiments, the thermal shields 337a, 337b, 339a, 339b can be identical or mirror images of one another. For example, in some embodiments, the exemplary embodiment of the thermal shield 335 shown in FIGS. 4-6 can represent the thermal shields 337a, 339a. Likewise, in some embodiments, a mirror image of the exemplary embodiment of the thermal shield 335 shown in FIGS. 4-6 can represent the thermal shields 337b, 339b.

Referring to FIG. 4, in some embodiments, the thermal shield 335 can optionally include a central portion 335a disposed between end portions 335b, 335c. For example, in some embodiments, end portions 335b, 335c can be provided in embodiments with edge directors 163a, 163b shown in FIG. 1. In some embodiments, the end portions 335b, 335c can provide clearance for portions of the edge directors 163a, 163b that can extend below the root 142 of the forming wedge 209. In some embodiments, the end portions 335b, 335c can be retracted and/or extended together with a single or a plurality of actuators. For example, in some embodiments, each end portion 335b, 335c can be extended and/or retracted independently along the respective extension direction 319a and the respective retraction direction 321a with corresponding actuators 341b, 341c. Additionally, in some embodiments, the central portion 335a can be extended and/or retracted together with the end portions 335b, 335c along the respective extension direction 319a and the respective retraction direction 321a with a single actuator (e.g., actuator 341a) or a plurality of actuators. In some embodiments, the end portions 335b, 335c can be adjusted together independently relative to the central portion 335a, or each end portion 335b, 335c can be adjusted independently from one another and from the central portion 335a.

In some embodiments, the central portion 335a of the thermal shield 335 can include a nose 401a that can, in some embodiments, extend along the entire length “L1” of the central portion 335a. Similarly, in some embodiments, if provided, the end portions 335b, 335c can include a respective nose 401b, 401c similar or identical to the nose 401a of the central portion 335a. In some embodiments, the respective nose 401b, 401c of the end portions 335b, 335c can extend along the entire length “L2”, “L3” of the end portions 335b, 335c. Additionally, in some embodiments, the noses 401a, 401b, 401c of the thermal shield 335 can, alone or in combination, define at least in part an outer end 402 of the thermal shield 335. In some embodiments, the outer end 402 can define, at least in part, a boundary of the opening 315 into the interior area 303 of the enclosure 301. For example, as shown in FIG. 3, in some embodiments, facing outer ends 402 of the pair of thermal shields 337a, 337b, 339a, 339b can define a width of a boundary 343 of the opening 315 into the interior area 303 of the enclosure 301. In some embodiments, the outer ends 402 of the thermal shield 335 can extend along a straight linear path parallel to one another to define a substantially constant width of the boundary 343 of the opening 315 along, for example, the entire length “L1” of the central portion 335a and/or along the entire lengths “L2”, “L3” of the end portions 335b, 335c.

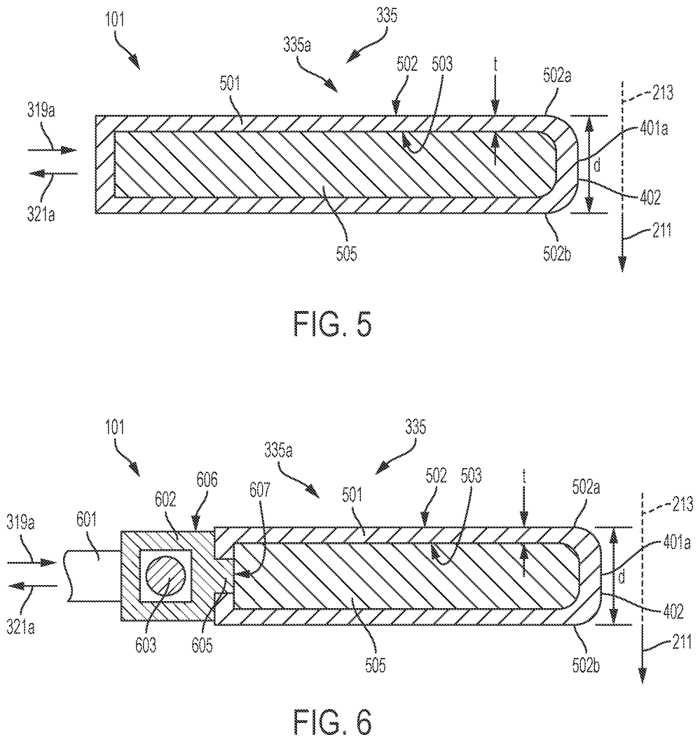

Additional features of the central portion 335a of the thermal shield 335 will be described below with the understanding that, unless otherwise noted, the end portions 335b, 335c can include the same or similar features as the central portion 335a without departing from the scope of the disclosure. For example, FIG. 5 shows a cross-sectional view of the thermal shield 335 taken along line 5-5 of FIG. 4, and FIG. 6 shows a cross-sectional view of the thermal shield 335 taken along line 6-6 of FIG. 4.

Referring to FIG. 5, in some embodiments, the thermal shield 335 can include a non-metallic outer shell 501 and a thermal insulating core 505. In some embodiments, the non-metallic outer shell 501 can include a first surface 502 defining an outer surface of the thermal shield 335 and a second surface 503 facing the thermal insulating core 505. In some embodiments, a dimension “d” of the thermal shield 335 extending parallel to the draw direction 211 from a first outer location 502a of the non-metallic outer shell 501 to a second outer location 502b of the non-metallic outer shell 501 can be from about 1.5 centimeters to about 2.5 centimeters. For example, as shown in FIG. 3, in some embodiments, the thermal shield 335 can be employed in the glass manufacturing apparatus 101 where features (e.g., dimension “d”) with respect to shape, size, and orientation of the thermal shield 335 may be imposed based on at least the presence of other structural features (e.g., forming vessel 140, doors 317a, 317b) as well as features or functions related to operation of the glass manufacturing apparatus 101.

Referring back to FIG. 5 and FIG. 6, in some embodiments, the non-metallic outer shell 501 can define a continuous surface. For example, in some embodiments, the non-metallic outer shell 501 (e.g., at least one of the first surface 502 and the second surface 503) can define a continuous layer of material devoid of, for example, exposed joints, seams, fasteners (e.g., screws, bolts), or other discontinuities. In some embodiments, a thickness “t” of the non-metallic outer shell 501 (e.g., average thickness of the non-metallic outer shell 501) can be defined between the first surface 502 and the second surface 503. In some embodiments, the thermal insulating core 505 can be enclosed entirely within the non-metallic outer shell 501. For example, in some embodiments, with respect to a cross-section of the thermal shield 335 taken perpendicular to the draw plane 213 (e.g., FIG. 5 and FIG. 6), the non-metallic outer shell 501 can extend entirely around (e.g. circumscribe) the thermal insulating core 505, and the thermal insulating core 505 can, therefore, be enclosed entirely within the non-metallic outer shell 501. Additionally, in some embodiments, one or more optional end caps (not shown) can be provided to enclose lateral end portions of the thermal shield 335 defined at opposing sides of the outer ends 402 (e.g., opposing sides of one or more of nose 401a, 401b, 401c). Therefore, for purposes of the disclosure, unless otherwise noted, the thermal insulating core 505 is considered to be enclosed entirely within the non-metallic outer shell 501 when, with respect to a cross-section of the thermal shield 335 taken perpendicular to the draw plane 213, the non-metallic outer shell 501 extends entirely around the thermal insulating core 505 irrespective of whether optional end caps are provided to enclose lateral end portions of the thermal shield 335.

Additionally, as shown in FIG. 6, in some embodiments, the thermal shield 335 can include a lug 602 connected to the non-metallic outer shell 501 and/or facing and/or abutting the thermal insulating core 505 at a joint 605. In some embodiments, a fastener 603 can connect a shaft 601 to the lug 602. In some embodiments, the shaft 601 can be connected to a manual or automatic actuator. For example, as shown in FIG. 3, in some embodiments, based at least on operation of the actuator 341a, the thermal shield 335 can be moved along at least one of the extension direction 319a and the retraction direction 321a based on a linked connection between the actuator 341a and at least one of the non-metallic outer shell 501 and the thermal insulating core 505 including the shaft 601, the lug 602, and the fastener 603, to adjust a width of the boundary 343 of the opening 315.

For purposes of the disclosure, the lug 602 can represent one or more structural features that can be connected to the non-metallic outer shell 501 in accordance with embodiments of the enclosure. Accordingly, it is to be understood that, in some embodiments, other structural features (not shown) can be connected to the non-metallic outer shell 501 to provide the thermal shield 335 with the non-metallic outer shell 501 (e.g., at least one of the first surface 502 and the second surface 503) defining a continuous surface without departing from the scope of the disclosure. In some embodiments, the lug 602 and the non-metallic outer shell 501 can be manufactured from the same material or one or more different materials that can be materially stitched or bonded together to provide a solid structure. For example, in some embodiments, the non-metallic outer shell 501 of the thermal shield 335 can include a plurality of components that, once connected together, function structurally and materially as a single component. In some embodiments, a solid structure can be provided by, for example, co-firing. In some embodiments, a co-fired feature can include a non-metallic (e.g., ceramic) support structure where conductive, resistive, and dielectric materials are fired (e.g., heated in a kiln) at the same time. Thus, for purposes of the disclosure, a co-fired feature can include structural and material properties of a continuous structure defining a continuous surface.

For example, as shown in FIG. 6, in some embodiments, the lug 602 (or other structural features, not shown) can be co-fired with the non-metallic outer shell 501, whereby an outer surface 606 of the lug 602 (or other structural features, not shown) and an outer surface (e.g., first surface 502) of the non-metallic outer shell 501 can define a continuous outer surface of the thermal shield 335. Likewise, in some embodiments, the lug 602 (or other structural features, not shown) can be co-fired with the non-metallic outer shell 501, whereby an inner surface 607 of the lug 602 (or other structural features, not shown) and an inner surface (e.g., second surface 503) of the non-metallic outer shell 501 can define a continuous surface facing and/or abutting the thermal insulating core 505. Accordingly, for purposes of the disclosure, in some embodiments, unless otherwise noted, a continuous surface can include a single structural feature defining a continuous layer of material devoid of, for example, exposed joints, seams, fasteners (e.g., screws, bolts), or other discontinuities as well as a plurality of structural features that are co-fired with each other to define a continuous layer of material devoid of, for example, exposed joints, seams, fasteners (e.g., screws, bolts), or other discontinuities.

In some embodiments, the non-metallic outer shell 501 can include ceramic material. For example, in some embodiments, the non-metallic outer shell 501 can be manufactured from a material including ceramic material. In some embodiments, the ceramic material can include silicon carbide, and, in some embodiments, the silicon carbide can include at least one of extruded silicon carbide (e.g., silicon carbide fabricated with a pre-form and then fired) and reaction bonded silicon carbide (e.g., SSC702). Additionally, in some embodiments, the thermal insulating core 505 can include a thermal insulating material providing one or more thermal insulative properties with respect to heat transfer (e.g., radiation heat transfer, conduction heat transfer) of the thermal insulating material. In some embodiments, the thermal insulating core 505 can include a thermal insulating refractory material. For example, in some embodiments, the thermal insulating core 505 can be manufactured from a material including a thermal insulating refractory material. For purposes of the enclosure, unless otherwise noted, the thermal insulating refractory material of the thermal insulating core 505 can be defined as a non-metallic, thermal insulating material having a thermal conductivity lower than the thermal conductivity of the material of the non-metallic outer shell 501. In some embodiments, the thermal insulating refractory material can include duraboard, rath board, or other refractory thermal insulation including boron carbide (e.g., Fiberfrax, Durablanket, Duraboard 3000). Additionally, in some embodiments, the thermal conductivity of the thermal insulating refractory material of the thermal insulating core 505 can be about one-hundred times to about two-hundred times less than the thermal conductivity of the ceramic of the non-metallic outer shell 501. For example, in some embodiments, the thermal conductivity of the thermal insulating refractory material of the thermal insulating core 505 can be less than or equal to about 1 watt per meter Kelvin (W/mK) and the thermal conductivity of the ceramic material of the non-metallic outer shell 501 can be about 170 W/mk, although other values can be provided in some embodiments without departing from the scope of the disclosure.

Thus, for purposes of the disclosure, in some embodiments, ceramic material can provide the non-metallic outer shell 501 with high temperature and chemical corrosion resistance properties. For example, in some embodiments, the non-metallic outer shell 501 including ceramic material can better resist structural degradation and deformation (e.g., warp, sag, creep, fatigue, corrosion, breakage, damage, cracking, thermal shock, structural shock, etc.) caused by exposure to one or more of an elevated temperature (e.g., temperatures at or below 1300° C.), a corrosive chemical (e.g., boron, phosphorus, sodium oxide), and an external force than, for example, other materials, including but not limited to, some metals and metal-alloys (e.g., steel, nickel) and some refractory materials including, but not limited to, thermal insulating refractory materials. Accordingly, in some embodiments, as compared to other materials including, but not limited to, some metals and some thermal insulating refractory materials, ceramic material can provide the non-metallic outer shell 501 of the thermal shield 335 with less structural degradation and increased structural integrity during operation of the glass manufacturing apparatus 101.

Likewise, for purposes of the disclosure, in some embodiments, thermal insulating refractory material can provide the thermal insulating core 505 with thermal insulative (e.g., low thermal conductivity) properties with respect to at least one of radiation heat transfer and conduction heat transfer. For example, in some embodiments, the thermal insulating core 505 including thermal insulating refractory material can better insulate the interior area 303 of the enclosure 301 and, therefore, provide a better thermal barrier between the interior area 303 and an area outside the enclosure 301 than for example, some metals and metal-alloys (e.g., steel, Nickel) and some ceramic materials including, but not limited to, silicon carbide. Accordingly, in some embodiments, as compared to other materials including, but not limited to, some metals and some ceramic materials, thermal insulating refractory material can provide the thermal insulating core 505 of the thermal shield 335 with better thermal insulative properties during operation of the glass manufacturing apparatus 101.

Providing the thermal shield 335 with the non-metallic outer shell 501 and the thermal insulating core 505 can provide several advantages. For example, as noted, the ceramic material of the non-metallic outer shell 501 can provide the thermal shield 335 with high temperature and chemical corrosion resistance properties, and the thermal insulating refractory material of the thermal insulating core 505 can provide the thermal shield 335 with thermal insulative (e.g., low thermal conductivity) properties including increased thermal insulative characteristics with respect to at least one of radiation heat transfer and conduction heat transfer. Moreover, in some embodiments, by enclosing the thermal insulating core 505 at least partially within or entirely within the non-metallic outer shell 501, the ceramic material of the non-metallic outer shell 501 can protect the thermal insulating refractory material of the thermal insulating core 505 by isolating the thermal insulating core 505 from exposure to one or more of an elevated temperature (e.g., temperatures at or below 1300° C.), a corrosive chemical (e.g., boron, phosphorus, sodium oxide), and an external force during operation of the glass manufacturing apparatus 101. Likewise, in some embodiments, by enclosing the thermal insulating core 505 at least partially within or entirely within the non-metallic outer shell 501, the thermal insulating refractory material of the thermal insulating core 505 can provide the thermal shield 335 with better thermal insulative properties than the ceramic material of the non-metallic outer shell 501 during operation of the glass manufacturing apparatus 101.

In some embodiments, providing the thermal shield 335 with a non-metallic outer shell 501 including ceramic material and a thermal insulating core 505 including thermal insulating refractory material can provide a relatively lightweight, high-strength thermal shield 335 that can be relatively less expensive, lighter, and exhibit a higher strength to weight ratio than, for example, other thermal shields. Furthermore, in some embodiments, providing the thermal shield 335 with a non-metallic outer shell 501 including ceramic material and a thermal insulating core 505 including thermal insulating refractory material can provide desirable thermal insulative properties with respect to the thermal boundary, defined at least in part by the closure 313, between the relatively higher temperature of the interior area 303 and the relatively lower temperature outside of the interior area 303. Accordingly, providing the thermal shield 335 with a non-metallic outer shell 501 including ceramic material and a thermal insulating core 505 including thermal insulating refractory material, in accordance with embodiments of the disclosure, can provide a thermal shield 335 that obtains several advantages during operation of the glass manufacturing apparatus 101 that cannot be achieved by thermal shields not including a non-metallic outer shell 501 including ceramic material and a thermal insulating core 505 including thermal insulating refractory material.

Moreover, in some embodiments, providing the thermal shield 335 with a non-metallic outer shell 501 including ceramic material and a thermal insulating core 505 including thermal insulating refractory material, where the non-metallic outer shell 501 (e.g., at least one of the first surface 502 and the second surface 503) defines a continuous surface can provide several advantages. For example, in some embodiments, providing the thermal shield 335 with a non-metallic outer shell 501 defining a continuous layer of material devoid of, for example, exposed joints, seams, fasteners (e.g., screws, bolts), or other discontinuities can provide a thermal shield 335 that can resist structural degradation and deformation (e.g., warp, sag, creep, fatigue, corrosion, breakage, damage, cracking, thermal shock, structural shock, etc.) caused by exposure to one or more of an elevated temperature (e.g., temperatures at or below 1300° C.), a corrosive chemical (e.g., boron, phosphorus, sodium oxide), and an external force than, for example, other structures, including but not limited to, structures including exposed joints, seams, fasteners (e.g., screws, bolts), or other discontinuities that, in some embodiments, may have a higher likelihood of structural degradation and deformation than a structure defining a continuous surface. Accordingly, providing the thermal shield 335 with a non-metallic outer shell 501 including ceramic material and a thermal insulating core 505 including thermal insulating refractory material, where the non-metallic outer shell 501 (e.g., at least one of the first surface 502 and the second surface 503) defines a continuous surface in accordance with embodiments of the disclosure can provide a thermal shield 335 that obtains several advantages during operation of the glass manufacturing apparatus 101 that cannot be achieved by thermal shields not including a continuous surface.

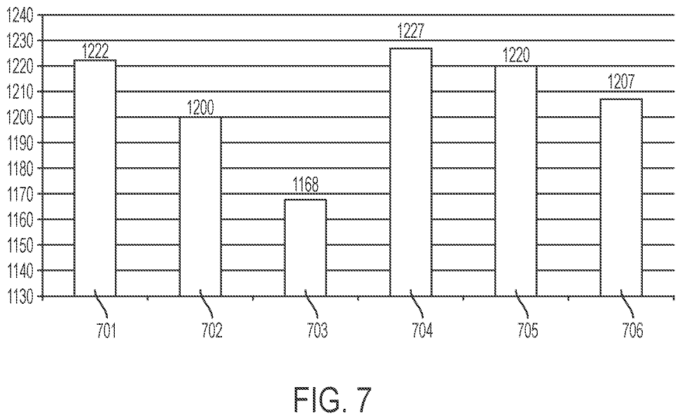

A thermal analysis simulation was performed to determine features of the thermal shield 335 in accordance with embodiments of the disclosure. For example, FIG. 7 shows a bar chart based on an analysis of exemplary thermal shields in accordance with embodiments of the disclosure, where the vertical axis represents temperature of a root of a glass ribbon in degrees Celsius (° C.) and the horizontal axis represents different thermal shields being compared. For example, with reference to FIG. 3, the vertical axis of FIG. 7 can represent the temperature in degrees Celsius (° C.) of the glass ribbon 103 at the root 142 of the forming wedge 209, and the horizontal axis can represent different thermal shields 337a, 337b being compared. For purposes of the thermal analysis simulation, a thermal shield 335 including the dimension “d” (see FIG. 5 and FIG. 6) of about 20.65 millimeters was assessed. However, unless otherwise noted, determinations based at least in part on the thermal analysis simulation can apply in a same or similar manner with respect to a thermal shield 335 including the dimension “d” less than about 20.65 millimeters as well as a thermal shield 335 including the dimension “d” greater than about 20.65 millimeters.

Regarding FIG. 7, bar 701 represents a root temperature of 1222° C. obtained during operation of the glass manufacturing apparatus 101 based on the simulation of a thermal shield (not shown) including a metallic outer shell having a thickness (e.g., average thickness) of about 3.175 millimeters, a thermal insulating core, and a relatively thick (e.g., 20.65 mm×28.575 mm) solid metal nose facing the draw plane 213, where the metallic outer shell and the solid metal nose were assumed to have an emissivity of about 0.2. Bar 702 represents a root temperature of 1200° C. obtained during operation of the glass manufacturing apparatus 101 based on the simulation of a thermal shield (not shown) including a metallic outer shell having a thickness (e.g., average thickness) of about 3.175 millimeters, a thermal insulating core, and a relatively thick (e.g., 20.65 mm×28.575 mm) solid metal nose facing the draw plane 213, where the metallic outer shell and the solid metal nose were assumed to have an emissivity of about 0.9. The assumed emissivity of 0.2 (bar 701) represents a relatively clean metallic surface corresponding to, for example, the outer surface of the thermal shield at the start of operation of the glass manufacturing apparatus 101. Conversely, the assumed emissivity of 0.9 (bar 702) represents a relatively heavily oxidized metallic surface corresponding to, for example, the outer surface of the thermal shield during operation of the glass manufacturing apparatus 101. In some embodiments, as observed by the lower root temperature of 1200° C., the simulated thermal shield (bar 702) with the relatively heavily oxidized metallic surface absorbed more heat and, therefore lowered the root temperature, than, for example, the simulated thermal shield (bar 701) with the relatively clean metallic surface, as observed by the higher root temperature of 1222° C.

In some embodiments, the ability to maintain a predetermined root temperature can provide several advantages including, but not limited to, a better quality glass ribbon 103, a more uniform temperature distribution across, for example, the width “W” (see FIG. 1) of the glass ribbon 103, and less supplemental heat input (e.g., lower energy usage) to maintain the predetermined root temperature. Accordingly, considering a root temperature of 1222° C. obtained for a thermal shield represented by bar 701 as a basis for comparison, additional thermal shields were simulated and compared.

Bar 703 represents a root temperature of 1168° C. obtained during operation of the glass manufacturing apparatus 101 based on the simulation of a thermal shield (not shown) defined as a solid ceramic (e.g., SSC702) structure. In some embodiments, a solid ceramic structure can provide high temperature and chemical corrosion resistance properties, as discussed above. However, as observed by the lower root temperature of 1168° C., in some embodiments, the thermal conductivity of a solid ceramic structure can be too high with respect to thermal insulative properties of the thermal shield. Therefore, in some embodiments, although the chemical corrosion resistance properties of a solid ceramic structure may be desirable, the thermal insulative properties of a solid ceramic structure (bar 703) can result in an unacceptable decrease of the root temperature relative to the base case (bar 701).

Bar 704, bar 705, and bar 706 represent root temperatures obtained during operation of the glass manufacturing apparatus 101 based on the simulation of a thermal shield 335 in accordance with embodiments of the disclosure (see FIGS. 4-6). In particular, bar 704 represents a root temperature of 1227° C. obtained during operation of the glass manufacturing apparatus 101 based on the simulation of the thermal shield 335 including a thickness “t” of the non-metallic outer shell 501 (e.g., average thickness of the non-metallic outer shell 501) of about 1.5875 millimeters. Bar 705 represents a root temperature of 1220° C. obtained during operation of the glass manufacturing apparatus 101 based on the simulation of the thermal shield 335 including a thickness “t” of the non-metallic outer shell 501 (e.g., average thickness of the non-metallic outer shell 501) of about 3.175 millimeters. Bar 706 represents a root temperature of 1207° C. obtained during operation of the glass manufacturing apparatus 101 based on the simulation of the thermal shield 335 including a thickness “t” of the non-metallic outer shell 501 (e.g., average thickness of the non-metallic outer shell 501) of about 6.35 millimeters.

Relative to the root temperature of 1222° C. obtained for the base case (bar 701), in some embodiments, the thermal shield 335 including a thickness “t” of the non-metallic outer shell 501 (e.g., average thickness of the non-metallic outer shell 501) of about 1.5875 millimeters (bar 704) can provide desirable thermal insulative properties with respect to maintaining the root temperature as demonstrated by the relatively higher root temperature of 1227° C., represented by bar 704. However, for purposes of the disclosure, it was determined that, although the root temperature may be desirable, the thermal shield 335 including a thickness “t” of the non-metallic outer shell 501 (e.g., average thickness of the non-metallic outer shell 501) of about 1.5875 millimeters (bar 704) can be relatively too fragile, brittle, and structurally unstable that cracking, fracture, or breakage of the non-metallic outer shell 501 can occur during operation of the glass manufacturing apparatus 101. Thus, in some embodiments, relative to bar 704, a relatively thicker non-metallic outer shell 501 (e.g., bar 705, bar 706) can provide the thermal shield 335 with a more structurally stable non-metallic outer shell 501 that can be less fragile and less brittle than a relatively thinner non-metallic outer shell 501 (e.g., bar 704). Therefore, in some embodiments, cracking, fracture, or breakage of a relatively thicker non-metallic outer shell 501 (e.g., bar 705, bar 706) can be less likely to occur during operation of the glass manufacturing apparatus 101 as compared to cracking, fracture, or breakage of a relatively thinner non-metallic outer shell 501 (e.g., bar 704).

However, regarding the ability of the thermal shield 335 to provide a thermal boundary between the relatively higher temperature of the interior area 303 of the enclosure 301 and the relatively lower temperature outside of the interior area 303, a trade-off can arise with respect to structural integrity of the non-metallic outer shell 501 and thermal insulative properties of the thermal insulating core 505. For example, as noted with reference to FIG. 3, in some embodiments, the thermal shield 335 can be employed in the glass manufacturing apparatus 101 where features (e.g., dimension “d”, see FIG. 5 and FIG. 6) with respect to shape, size, and orientation of the thermal shield 335 may be imposed based on at least the presence of other structural features (e.g., forming vessel 140, doors 317a, 317b) as well as features or functions related to operation of the glass manufacturing apparatus 101. Thus, considering a given dimension “d” of the thermal shield 335, as thickness “t” of the non-metallic outer shell 501 increases, thickness (e.g., volume) of the thermal insulating core 505 correspondingly decreases. Conversely, considering a given dimension “d” of the thermal shield 335, as thickness “t” of the non-metallic outer shell 501 decreases, thickness (e.g., volume) of the thermal insulating core 505 correspondingly increases.

Accordingly, for a given dimension “d” of the thermal shield 335, as thickness “t” of the non-metallic outer shell 501 increases, structural integrity of the non-metallic outer shell 501 increases, thickness of the thermal insulating core 505 decreases, and, therefore, the ability of the thermal shield 335 to provide a thermal insulative barrier likewise decreases. Conversely, for a given dimension “d” of the thermal shield 335, as thickness “t” of the non-metallic outer shell 501 decreases, structural integrity of the non-metallic outer shell 501 decreases, thickness of the thermal insulating core 505 increases, and, therefore, the ability of the thermal shield 335 to provide a thermal insulative barrier likewise increases.

Referring again to FIG. 7, relative to the root temperature of 1222° C. obtained for the base case (bar 701), as observed by the relatively lower root temperature of 1207° C. (bar 706), in some embodiments, the thermal shield 335 including a thickness “t” of the non-metallic outer shell 501 (e.g., average thickness of the non-metallic outer shell 501) of about 6.35 millimeters (bar 706), although more structurally stable than, for example, bar 704, can reduce the thickness of the thermal insulating core 505 and provide the thermal shield 335 with less desirable thermal insulative properties with respect to maintaining the root temperature. For purposes of the disclosure, based on the simulated thermal analysis, it was determined that, the thermal shield 335 including a thickness “t” of the non-metallic outer shell 501 (e.g., average thickness of the non-metallic outer shell 501) of about 3.175 millimeters (bar 705) can provide the thermal shield 335 with both desirable structural properties (e.g., based at least in part on the structural characteristics of the non-metallic outer shell 501) as well as desirable thermal insulative properties (e.g., based at least in part on the thermal insulative properties of the thermal insulating core 505). Therefore, in some embodiments, based on the simulated thermal analysis, the thermal shield 335 including a thickness “t” of the non-metallic outer shell 501 (e.g., average thickness of the non-metallic outer shell 501) of about 3.175 millimeters (bar 705) can provide a thermal barrier between the relatively higher temperature of the interior area 303 of the enclosure 301 and the relatively lower temperature outside of the interior area 303 that can maintain a predetermined root temperature during operation of the glass manufacturing apparatus 101.

Accordingly, based on the simulated thermal analysis, in some embodiments, a thickness “t” of the non-metallic outer shell 501 (e.g., average thickness of the non-metallic outer shell 501) defined between the first surface 502 and the second surface 503 can be from about 2.8 millimeters to about 3.5 millimeters (e.g., +/−10% of 3.175 millimeters, bar 705). Additionally, in some embodiments, the thickness “t” of the non-metallic outer shell 501 (e.g., average thickness of the non-metallic outer shell 501) can be from about 3 millimeters to about 3.3 millimeters (e.g., +/−5% of 3.175 millimeters, bar 705). Likewise, in some embodiments, the thickness “t” of the non-metallic outer shell 501 (e.g., average thickness of the non-metallic outer shell 501) can be about 3.175 millimeters, as represented by bar 705.

Referring back to FIG. 3, in some embodiments, the thermal shield 335 including one or more features in accordance with embodiments of the disclosure can, therefore, obstruct at least a portion of the opening 315 in the enclosure 301 and, for example, provide a thermal barrier (e.g., thermal insulative boundary with respect to at least one of radiation heat transfer and conduction heat transfer) between the relatively higher temperature of the interior area 303 of the enclosure 301 and the relatively lower temperature outside of the interior area 303. Additionally, in some embodiments, the thermal shield 335 including one or more features in accordance with embodiments of the disclosure can control an amount and/or rate of convective air flowing through the boundary 343 of the opening 315 into the interior area 303 of the enclosure 301. In some embodiments, controlling heat transfer (e.g., one or more of radiation heat transfer, conduction heat transfer, and convection heat transfer) into or out of the enclosure 301 can at least one of adjust and maintain the temperature of the interior area 303 including the temperature of the root 142 as well as the temperature of the glass ribbon 103 within the interior area 303 and the temperature of the glass ribbon 103 outside the interior area 303.

Additionally, in some embodiments, providing the thermal shield 335 including one or more features in accordance with embodiments of the disclosure can reduce or prevent warping and permanent deformation of the thermal shield 335, thereby maintaining the shape (e.g., extending along a straight linear path) of the outer end 402 of the nose 401a to provide a consistent spacing of the facing outer ends 402 along the entire length “L1” of the central portion 335a of the thermal shield 335. Likewise, in some embodiments, providing the thermal shield 335 including one or more features in accordance with embodiments of the disclosure can provide more uniform heat transfer characteristics along the width “W” of the glass ribbon 103. Moreover, in some embodiments, providing the thermal shield 335 including one or more features in accordance with embodiments of the disclosure can prevent contamination of the major surfaces 215a, 215b of the glass ribbon 103 with, for example, debris (e.g., particles, oxidation) that may occur based on other designs of thermal shields. Accordingly, in some embodiments, consistent heat transfer can be achieved throughout the entire length “L1” of the thermal shield 335 along the width “W” of the glass ribbon 103 over longer production campaigns during operation of the glass manufacturing apparatus 101. Thus, in some embodiments, providing the thermal shield 335 including one or more features in accordance with embodiments of the disclosure can maintain the pristine condition of the major surfaces 215a, 215b of the glass ribbon 103 and control the thickness “T” of the glass ribbon 103 that may not be possible with prior designs of some conventional thermal shields that resulted in one or more of warping, oxidation, permanent deformation, and poor thermal insulative properties.

It should be understood that while various embodiments have been described in detail with respect to certain illustrative and specific embodiments thereof, the present disclosure should not be considered limited to such, as numerous modifications and combinations of the disclosed features are possible without departing from the scope of the following claims.

1. A glass manufacturing apparatus comprising:
an enclosure comprising an interior area;
a vessel positioned at least partially within the interior area of the enclosure, the vessel comprising a trough and a forming wedge comprising a pair of downwardly inclined surfaces that converge at a root of the vessel; and
a thermal shield obstructing at least a portion of an opening of the enclosure, the thermal shield comprising a non-metallic outer shell and a thermal insulating core.

2. The glass manufacturing apparatus of claim 1, wherein the non-metallic outer shell comprises ceramic material.

3. The glass manufacturing apparatus of claim 2, wherein the ceramic material comprises silicon carbide.

4. The glass manufacturing apparatus of claim 1, wherein the non-metallic outer shell comprises a first surface defining an outer surface of the thermal shield and a second surface facing the thermal insulating core, and a thickness of the non-metallic outer shell is from about 2.8 millimeters to about 3.5 millimeters.

5. The glass manufacturing apparatus of claim 4, wherein the thickness of the non-metallic outer shell is from about 3 millimeters to about 3.3 millimeters.

6. The glass manufacturing apparatus of claim 1, wherein the thermal insulating core is enclosed entirely within the non-metallic outer shell.

7. The glass manufacturing apparatus of claim 1, wherein the non-metallic outer shell defines a continuous surface.

8. The glass manufacturing apparatus of claim 1, wherein the thermal shield is movable along an adjustment direction extending perpendicular to a draw plane, the draw plane extending from the root of the vessel through the opening of the enclosure.

9. A method of manufacturing a glass ribbon with the glass manufacturing apparatus of claim 1, the method comprising flowing molten material along each surface of the pair of downwardly inclined surfaces, fusing the flowing molten material off the root of the vessel into a glass ribbon, and drawing the glass ribbon along a draw path extending from the root of the vessel through the opening of the enclosure.

10. A glass manufacturing apparatus comprising:
an enclosure comprising an interior area;
a vessel positioned at least partially within the interior area of the enclosure, the vessel comprising a trough and a forming wedge comprising a pair of downwardly inclined surfaces that converge at a root of the vessel; and
a thermal shield moveable along an adjustment direction extending perpendicular to a draw plane, the draw plane extending from the root of the vessel through an opening of the enclosure in a draw direction, and the thermal shield comprising a non-metallic outer shell.

11. The glass manufacturing apparatus of claim 10, wherein the non-metallic outer shell comprises ceramic material.

12. The glass manufacturing apparatus of claim 11, wherein the ceramic material comprises silicon carbide.

13. The glass manufacturing apparatus of claim 10, wherein the non-metallic outer shell defines a continuous surface.

14. The glass manufacturing apparatus of claim 10, wherein a dimension of the thermal shield extending parallel to the draw direction from a first outer location of the non-metallic outer shell to a second outer location of the non-metallic outer shell is from about 1.5 centimeters to about 2.5 centimeters.

15. The glass manufacturing apparatus of claim 10, wherein the thermal shield comprises a thermal insulating core, the non-metallic outer shell comprising a first surface defining an outer surface of the thermal shield and a second surface facing the thermal insulating core.

16. The glass manufacturing apparatus of claim 15, wherein a thickness of the non-metallic outer shell is from about 2.8 millimeters to about 3.5 millimeters.

17. The glass manufacturing apparatus of claim 15, wherein the thermal insulating core is enclosed entirely within the non-metallic outer shell.

18. A method of manufacturing a glass ribbon with the glass manufacturing apparatus of claim 10, the method comprising moving the thermal shield along the adjustment direction to adjust a width of the opening.

19. The method of claim 18, further comprising flowing molten material along each surface of the pair of downwardly inclined surfaces, fusing the flowing molten material off the root of the vessel into a glass ribbon, and drawing the glass ribbon in the draw direction.
